(19) United States
(12) Patent Application Publication
(10) Pub. No.: US 2016/0122444 A1
(43) Pub. Date: May 5, 2016

(54) CHITIN-GLUCAN COMPLEXES AND METHOD FOR THE PREPARATION THEREOF FROM CHITIN-RICH BIOMATERIALS

(71) Applicant: UNIVERSIDAD DEL VALLE, Santiago de Cali (CO)

(72) Inventors: Gustavo Eduardo BOLAÑOS BARRERA, Santiago de Cali (CO); Laura Martiza ORDOÑEZ BELTRAN, Santiago de Cali (CO); Jaime Andres GARCIA DIOSA, Santiago de Cali (CO)

(21) Appl. No.: 14/896,392

(22) PCT Filed: Oct. 7, 2013
(86) PCT No.: PCT/IB2013/059168

§ 371 Date: Dec. 6, 2015

(30) Foreign Application Priority Data
Jun. 7, 2013 (CO) 13-138097

(51) Int. Cl. C08B 37/08

(52) U.S. Cl. CPC C08B 37/003

(57) ABSTRACT

The present invention is related to a novel process for the preparation of chitin-glucan or chitosan-glucan complexes from raw materials of biological origin rich in chitin, such as mycelium of micro-fungi and exoskeletons of crustaceans, where the product obtained presents a chitin proportion between 19 and 55% and average molecular weight between 1.7 and 155 kDa.

### FIELD OF THE INVENTION

The present invention is related to a novel process for the preparation of chitin-glucan or chitosan-glucan complexes from raw materials of biological origin rich in chitin.

### BACKGROUND OF THE INVENTION

Chitin is the second most abundant biopolymer after cellulose; it is found naturally forming part of the structures of many living beings, among them, principally, the cell wall of micro-fungi from the genus Aspergillus, like for example, Aspergillus niger (the fungus used industrially to produce citric acid), and from the exoskeleton of crustaceans like crab, shrimp, and lobster. In said structures, chitin appears in chemical combination with a variety of compounds, among which glucans are highlighted [1,2].

For several years, processes have been developed to obtain chitin and chitin-glucan complexes, or their deacetylated derivates (which are more soluble in water and are known as chitosan and chitosan-glucan complexes), from the mycelium of micro-fungi from the genus Aspergillus and exoskeletons of crustaceans. Chitin, chitosan, and the complexes indicated are raw materials for the manufacture of many products useful in several fields of the economy, like for example adsorbents for water treatment, pharmaceutical, nutritional, and nutraceutical products; food preservatives; agents for dyslipidemia control; supports for enzymes and other catalysts; fibers for the elaboration of surgical sutures; films to produce artificial skin and for bioabsorbable bandages; vehicles for controlled drug dosage; accelerators for wound healing, anticoagulant agents, inhibitors of microbial activity, etc. Open scientific literature reports a very high number of applications for these products [3-5].

The processes that have been reported to obtain chitin and chitin-glucan complexes or their deacetylated derivates use a chemical path based on the treatment of said natural raw materials with large amounts of concentrated alkaline solutions (between 200 and 500% the amount of raw material) and, thereafter, with acid solutions. This generates a problem in handling polluting effluents that in many cases limits the applicability of these technologies.

Other processes reported are based on the use of enzymes that permit degrading the biomaterial and, thus, producing the chitin or chitin-glucan complexes and in some cases the corresponding deacetylated materials [6]. The enzymatic processes require long processing times, which leads to the need to use reactors of large volumes and at higher costs, both in investment and operation.

The scientific literature has reported the use of subcritical water to break the chemical bonds present in materials of natural origin. For example, it is known that it is technically possible carry out lignocellulose hydrolysis [7-9] with water under conditions close to the critical point and with a holding time between 0.05 and 10 s, to obtain hydrolysis and degradation products like cellobiose, glucose, fructose, and glycoaldehydes. An even more relevant example consists of the experiments by Sasaki [10] on the treatment of sugarcane bagasse in subcritical water at temperatures of between 200 and 230° C. At these conditions, the bonds that make up lignin break up (which maintain cellulose fibers joined) to produce microcrystalline cellulose. The temperature and pressure conditions indicated are sufficiently high to break up the chemical bonds present in these structures of plant origin, which are relatively stronger than many of the bonds present in the raw materials rich in chitin.

The aforementioned suggests that if raw materials rich in chitin are subjected to treatment with subcritical water at less aggressive conditions than those presented in the studies mentioned, eventually, it would be feasible to break up the bonds that bind the biopolymers to the cellular structures of the raw material.

Other documents revealed by the state-of-the-art and related to methods to obtain chitin are discussed by the following:

The document for patent JP 3593024 (Ishikawa Prefecture, Matsukawa Kagaku KK) reveals a method for depolymerization of a chitosan-type polysaccharide, cellulose or its derivates using high pressures (between 1000 and 4000 atm), temperature (0 to 200° C.), and an oxidizing agent (sodium perborate) in distilled water between 10 and 30 min.

Patent JP 05-031000 (Kobe Steel Ltd) illustrates a process for the hydrolysis and thermal decomposition of natural polymers (cellulose, lignin, chitosan) and synthetic polymers (polyurethane, polystyrene, polyethylene, polypropylene), which comprises treating the polymers at a temperature between 250 and 450° C. and pressure between 5 and 50 MPa (subcritical or supercritical water) in the presence of an acid (sulfuric, hydrochloric, or phosphoric) in a concentration below 2%, preferably 0.05%, for less than 2 min.

The publication of patent JP64-011101 refers to a method for the production of chitosan of low molecular weight from materials rich in chitin, like exoskeletons of crustaceans that comprises the degradation of proteins and chitin acetylation without affecting the amino group due to treatment of the material in a solution of chlorine dioxide in solution or stabilized (0.05-2% p/p) at a temperature between 40 and 80° C., under constant agitation with prior pH adjustment of the material's solution at a value between 7 and 10.

In spite of developments around processes to obtain chitin and chitin-glucan complexes described in the literature, there is need for a process that permits obtaining chitin and chitin-glucan complexes from raw materials like mycelium from micro-fungi and exoskeletons of crustaceans without the limitations of the state of the art, that is in short times and without the need to use large amounts of caustic or acid solutions.

The present invention permits conducting the separation of chitin and chitin-glucan complexes from mycelium from micro-fungi and exoskeletons of crustaceans of added value for industrial applications with hot and compressed liquid water at pressures and temperatures below the critical point of water.

### BRIEF DESCRIPTION OF THE FIGURES

FIG. 1 shows a scheme of the invention process for the preparation of chitin-glucan or chitosan-glucan complexes from raw materials of biological origin rich in chitin.

FIG. 2 shows a scheme of the behavior of temperatures of the reactor's external surface and of the fluid in the reactor used in the invention process.

FIG. 3 shows the infrared spectrum of chitin-glucan complex samples obtained via the novel invention process.

### OBJECTS OF THE INVENTION

In a first object, the invention is related to a process for the preparation of chitin-glucan or chitosan-glucan complexes from raw materials of biological origin rich in chitin.

In a second object, the invention divulges a chitin-glucan complex with a chitin proportion between 19 and 55% and average molecular weight between 1.7 and 155 kDa obtained from raw materials of biological origin rich in chitin.

### DETAILED DESCRIPTION OF THE INVENTION

In a first object, the invention divulges a process for the preparation of chitin-glucan complexes from raw materials of biological origin rich in chitin, which comprises the stages of:
a) Washing the biomaterial selected from mycelium from micro-fungi or exoskeletons of crustaceans to neutral pH, dry until reaching relative humidity below 20% and diminishing the particle size, where more than 90% of the particles present an average diameter lower than or equal to 1 mm.
b) Mixing at room temperature the biomaterial pretreated in a proportion between 10 and 30%, water between 70 and 90%, and a nonionic emulsifying agent with HLB between 10 and 20 in a proportion between 0.01 and 1%.
c) Heating the mixture at a temperature between 100 and 370° C., preferably between 200 and 250° C., where the operating pressure is equal to or above the water vapor pressure at the temperature selected for the reaction, and let react between 0.1 and 50 s, preferably between 5 and 12 s.
d) Cooling the mixture to a temperature between 30 and 35° C. between 0.1 and 30 s.
e) Washing with water to remove proteins and sugars and recover the solid
f) Drying the solid until reaching humidity percentage below 18%

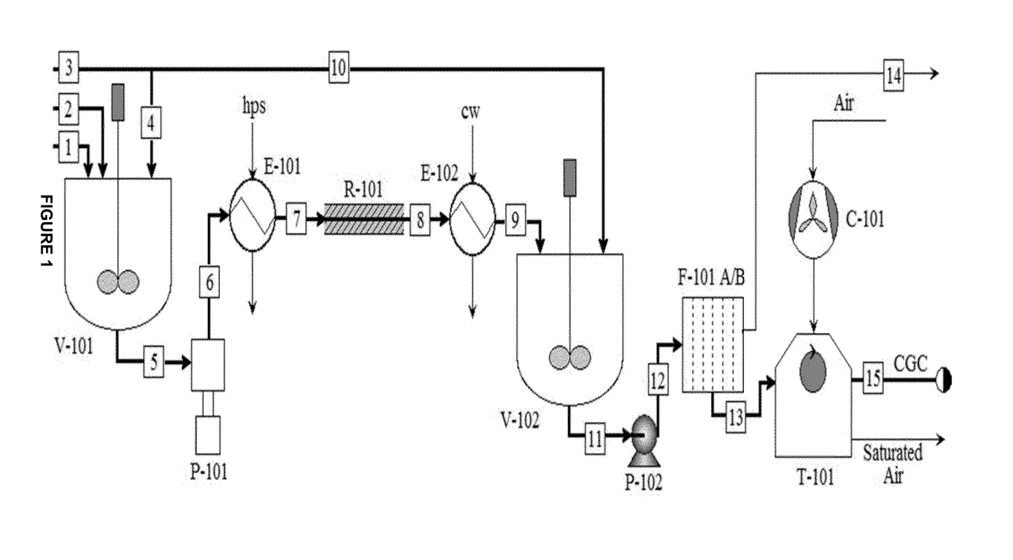

FIG. 1 shows in detail a scheme of the invention process that uses as source of chitin mycelium from micro-fungi or exoskeletons of crustaceans (1), which is taken to a mixing tank (V101) where water is added (4) along with a nonionic emulsifier (2), in the following proportions: water between 70 and 90%, biomaterial between 10 and 30%, emulsifier between 0.01 and 1%. The mixture is agitated lightly to form an emulsion that is susceptible to pumping. The emulsion, thus, formed must be stable at least for some hours to permit uniform pumping of the material.

The emulsion is pumped at high pressure using a diaphragm-type positive displacement pump (P101). The diaphragm pump has the advantage that there is no direct contact of the pump's piston or pistons with the fluid without possibility of polluting the product with lubricating oil from the pump, or obstructing the pump's mechanisms with the emulsified material.

The pump's output pressure must be equal to or higher than that of water vapor pressure at the reaction temperature selected and, in any case, above that of water vapor pressure at the maximum operating temperature to always keep it in liquid phase.

The emulsified and compressed material (6) is heated to a temperature between 200 and 250° C. by using a heat exchanger (E101) that operates with high-pressure vapor, but any other device may be suitable for this purpose (for example, electric heating, thermal oil, etc.).

The hot and compressed material (7) then passes through a reactor (R101) designed to withstand pressures and reaction temperatures, and usually consists of a piece of stainless steel high-pressure tubing, with a length to supply the adequate holding time to allow for the hydrolysis reactions that permit obtaining chitin and/or chitin-glucan complexes. The holding time is between 0.1 and 50 s, preferably between 5 and 12 s.

The material leaving the reactor (8) is quickly cooled by using a heat exchanger (E102) that uses water or another cooling fluid commonly used like a mixture of water with a refrigerant like ethyleneglycol, or with salts.

Upon cooling the reactive mass (9), it is mixed with water (10) to carry out a wash that permits removing proteins, sugars, and other unwanted components that may have been formed during the reaction, to remove the solid part from the reactive mass. This may be done in any equipment suitable for said task, like for example, in a tank (V102) where the cold reactive mass is collected and to which water is added to conduct the washing to, thereafter, pump the mass through a filter press (P102/F101A/B) to remove the wash liquid and collect the solid part, which corresponds to the product which is the object of the present invention.

The moist material leaving the filter (13) contains high proportions of chitin and/or chitin-glucan complexes. To remove the moisture, said moist product is dried at low temperature (T101) to remove the residual moisture; thereafter, it is packed and stored.

As an alternative, the invention process may be modified for the preparation of chitosan-glucan complexes from raw materials of biological origin rich in chitin, which comprises the stages of:
a) Washing the biomaterial selected from mycelium of micro-fungi or exoskeletons of crustaceans to neutral pH, dry until reaching relative humidity below 20% and diminishing the particle size, where more than 90% of the particles present an average diameter lower than or equal to 1 mm.
b) Mixing, at room temperature, the biomaterial pretreated in a proportion of between 10 and 30%, water between 70 and 90%, a nonionic emulsifying agent with HLB between 10 and 20 in a proportion between 0.01 and 1%, sodium hyposulfite in a proportion between 0.1 and 5%, and base selected from sodium hydroxide, potassium hydroxide, lithium hydroxide, calcium hydroxide, or magnesium hydroxide in a proportion between 10 and 30%.
c) Heating the mixture at a temperature between 100 and 370° C., preferably between 200 and 250° C., where the operating pressure is equal to or above the water vapor pressure at the temperature selected for the reaction and let react between 0.1 and 50 s, preferably between 5 and 12 s.
d) Cooling the mixture to a temperature between 30 and 35° C. during a time between 0.1 and 30 s.
e) Washing with water to remove proteins and sugars and recover the solid
f) Drying the solid until reaching humidity percentage below 18%

When adding to the initial mix a selected base of, but not restricted to: sodium hydroxide, potassium hydroxide, lithium hydroxide, calcium hydroxide, or magnesium hydroxide it is possible to carry out within the process the deacetylation reactions of the chitin-glucan complex; the addition of small amounts of sodium hyposulfite to the reactive mass permits inhibiting the Maillard reaction and avoiding darkening of the product that occurs as a result of said reaction, which results are specially important when the operating temperatures are above 230° C.

### EXAMPLES

The equipment used experimentally was designed according to the characteristics of the description of the invention and FIG. 1. This equipment permits operating at temperatures up to 300° C., pressures to 29 MPa and holding times up to 50 s. The water pumping system permits delivering the water flow to the system, either directly to the reactor so that it can reach the operating conditions or to a biomaterial injector. Said injector is charged with the suspension of the biomaterial and has a moving piston that allows it to act as a syringe when the water is pressure pumped to the upper part of the injector, causing the biomaterial to enter the reactor.

The reactor was manufactured with high-pressure tubing (⅛″) and heated electrically. Along the tubing four thermocouples were installed to record its surface temperature and a fifth thermocouple was inserted at the exit of the reactor to record the final temperature of the reacting mixture. After the reactor, the product passes through a heat exchanger to lower its temperature to 35° C.

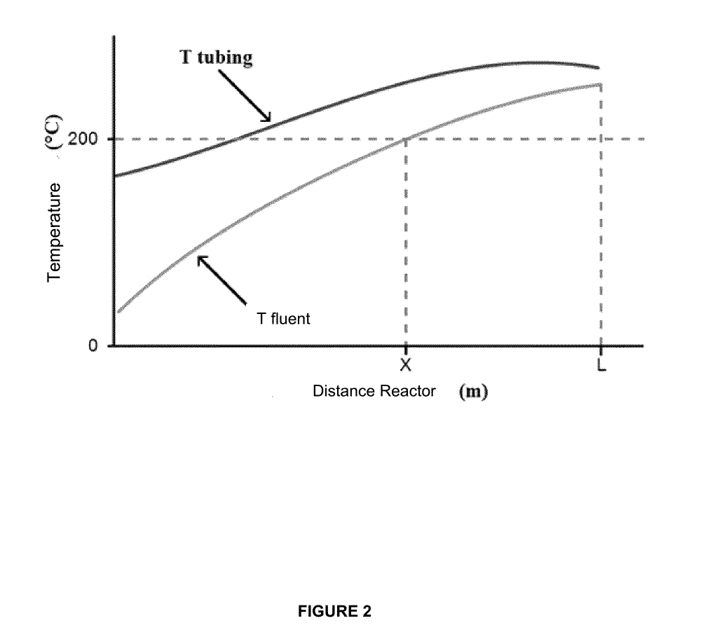

FIG. 2 shows a scheme of the typical behavior of temperatures in the reactor's external surface and of the fluid inside it. To determine the mean temperature ( T̅), the following equation was used:

$$\overline{T} = \frac{1}{L - X} {\int }_{X}^{L} {T}_{f} ( X ) d X \qquad ( 1 )$$

where L is the total length of the tubing in the reactor to a part of the heat exchanger (where the fluid's temperature is still 200° C.) and X is the length of the tubing where the fluid reaches 200° C., temperature at which the breakup of the bonds by the subcritical water becomes relevant.

The fluid's temperature profile (T_{f}) was determined by using data of surface temperature of the tubing obtained from the four thermocouples located along the reactor and from an energy balance. The reaction time (t) was defined as the time elapsed between the moment the fluid reaches 200° C. and the exit from the reactor. It was calculated according to:

$$t = \frac{( L - X ) {A}_{t}}{Q} \qquad ( 2 )$$

where Aₜ is the tubing's transversal area and Q in the fluid volume.

### Example 1

To illustrate the process for the preparation of chitin-glucan complexes of the invention, the detailed process is presented from mycelium of Aspergillus niger, a micro-fungi rich in chitin from the production of citric acid. The mycelium was subjected to five washes with distilled water to remove soluble impurities (citric acid residues, for example), until reaching neutral pH. Thereafter, it was subjected to drying in a fluidized bed dryer, using dry air at room temperature to avoid heating the material and the possible degradation of thermosensitive chemical compounds. The dry material was sieved and the material passing through 16 mesh was collected (average particle diameter 1 mm) to serve as raw material. A light brown solid was obtained with absolute humidity of 16.7%, which was stored at −20° C. before using.

The mycelium washed, dried, and sieved was used to prepare an aqueous suspension to feed the treatment system in subcritical water in the following proportions: 91.01% distilled water, 8.24% dry mycelium, and 0.74% of 2-(2-(4-nonylphenoxy)ethoxy)ethanol (ARKOPAL®). This formulation permitted the suspension to remain stable for at least two days.

The mycelium suspension was subjected to the treatment process in subcritical water, at temperatures between 214 and 231° C. and reaction times between 5.4 and 10 s. The reaction products were subjected to centrifugation (3000 rpm for 15 min) to remove soluble products, like proteins and sugars. Four centrifugation cycles were used, each time washing the solid with distilled water. The resulting solid phase was frozen in liquid nitrogen and maintained at −20° C. for 24 h before subjecting it to lyophilization. The resulting solid was subjected to chemical characterization tests.

Product yield was calculated regarding the amount of mycelium processed, IR spectrophotometry (Shimadzu FTIR Affinity) analysis was conducted, along with the elemental analysis to know the degree of chitin acetylation in an elemental analyzer (Thermo Electron Flash EA 1112). Bearing in mind that a typical chitin sample is 90% acetylated and that the structural formula of the chitin monomer completely acetylated is C₈NO₅H₁₃ and of the deacetylated is C₆NO₄H₁₁, an expression was developed that permits calculating the chitin concentration in each sample, using the amount of nitrogen measured in the respective elemental analysis, which corresponds only to the nitrogen present in chitin with the assumption that all the proteins were removed during centrifugation and washing of the sample. The equation is:

Q=14.199N

where:
Q=chitin concentration in the sample (%),
N=nitrogen content in the sample according to the elemental analysis (%)

To determine the molecular weight, the Mark-Houwink equation was used that relates the intrinsic viscosity with the molecular weight through two constants (K and a), which depend on the polymer-solvent mixture used in measuring the intrinsic viscosity, as shown in the equation:

η=0.26(M_{w})/^{0.56}

where:
η=intrinsic viscosity (mL/g),
M_{w}=molecular weight of the polymer (Da),
k, α=constants dependent on the polymer-solvent mixture.

Although several solvents may be used to carry out the dissolution, an aqueous mixture of 8% sodium hydroxide and 4% urea does not generate important variations in the degree of chitin acetylation or in the sample's relative viscosity, making it a stable mixture to measure the molecular weight [11]. Additionally, said mixture does not dissolve sugars bound to proteins, which helps to prove that the product is not bound to these. The values of k and a reported for the aqueous mixture of 8% sodium hydroxide, 4% urea and chitin are, respectively, 0.26 and 0.56 at 25° C. [11].

Bearing in mind the aforementioned, the product was dissolved in the aqueous mixture indicated to make up five solutions with different concentrations, from 0.2 to 1 mg/mL. A viscometer (Cannon-Fenske No. 50) was used to conduct the procedure described by Weska [12], which plots the viscosity measured at different concentrations and extrapolated at zero concentration to obtain the intrinsic viscosity.

Table 1 shows the operating conditions for five experimental runs. In these, pressure was fixed at 3000 psi, using different temperatures and holding times (in all cases, the holding time was below 10 s).

TABLE 1
Operating conditions for five experimental runs

| | Average | |
|---|---|---|
| | temperature | Holding time |
| Test | (° C.) | (s) |
| 1 | 274 | 34.8 |
| 2 | 257 | 24.4 |
| 3 | 234 | 17.2 |
| 4 | 231 | 13.5 |
| 5 | 214 | 5.0 |

The product obtained at the two highest temperatures (257 and 274° C.) showed a dark color, which is mainly due to the progress of Maillard's reaction and a strong odor of caramelized sugar. Table 2 shows the results obtained for tests 4 and 5, which obtained, respectively, a mixture of chitin at 80.9% with sugars and chitin-glucan complex with traces of sugars and a chitin content of 42.9%.

The yields show that as the conditions of temperature and pressure become higher, sugars and part of the chitin are destroyed, with the latter being the most chemically resistant; hence, the yield is inversely proportional to the chitin purity.

TABLE 2
Results obtained for tests 4 and 5

| | | Sample | |
|---|---|---|---|
| Characteristic | | 4 | 5 |
| Elemental analysis (%) | C | 43.9 | 43.6 |
| | N | 5.7 | 3.0 |
| | H | 6.5 | 6.8 |

| | | |
|---|---|---|
| Chitin concentration (%) | 80.9 | 42.9 |
| Molecular weight (KDa) | 30.0 | 43.0 |
| Yield (%) | 13.9 | 25.8 |

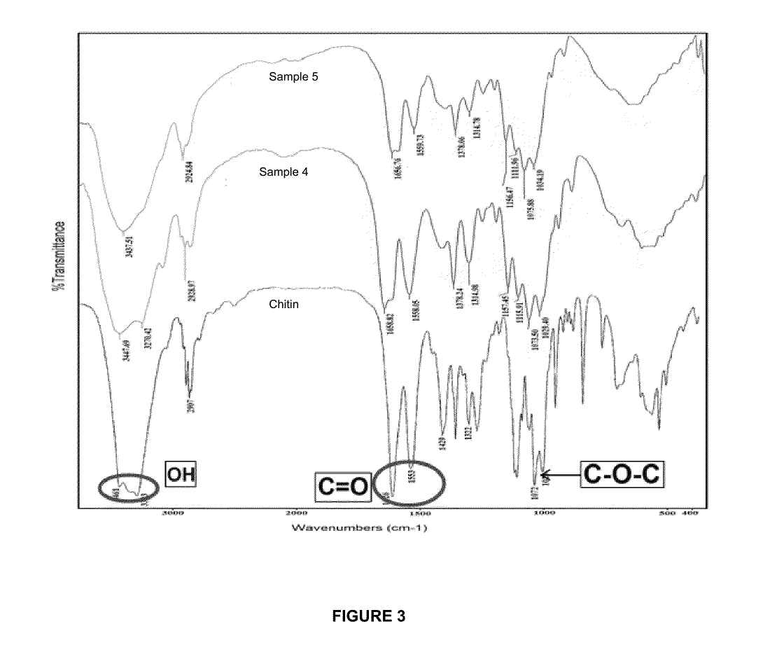

FIG. 3 shows the infrared spectra of the chitin and of the samples obtained in tests 4 and 5, which identify the chitin functional groups.

### Example 2

A set of experimental runs was carried out, varying the reaction temperature between 207 and 255° C. and holding time between 4.7 and 10.8 s. Table 3 shows the characteristics of the chitin-glucan complexes obtained at different conditions. According to these results, it is evident that with the process object of the invention a large variety of chitin-glucan complexes can be obtained with different chitin concentrations that may be used in a broad range of applications. In effect, the development process permitted in this example to obtain yields varying between 22 and 68%, with a chitin proportion of 19.7 to 54.2% and molecular weights between 1.7 and 155.2 kDa. Additionally, the results presented in Example 1 show that it would be possible to isolate chitin with purity above 80% with more drastic operating conditions.

TABLE 3
Characteristics of the chitin-glucan complexes obtained at different
conditions

| Operating | | Characteristics of the product | | | | | |
|---|---|---|---|---|---|---|---|
| conditions | | | Elemental | | | Chitin con- | Molecular |
| Temperature | Time | | analysis (%) | | | centration | weight |
| (° C.) | (s) | Yield (%) | C | N | H | (%) | (kDa) |
| 214 | 5.4 | 44.8 | 41.9 | 2.3 | 6.4 | 32.5 | 44.2 |
| 214 | 10.0 | 45.2 | 42.4 | 2.2 | 6.4 | 31.4 | 18.8 |
| 231 | 5.4 | 35.7 | 44.3 | 2.8 | 7.0 | 39.7 | 16.4 |
| 231 | 10.0 | 24.9 | 42.5 | 3.8 | 6.8 | 54.2 | 1.7 |
| 222 | 7.5 | 57.9 | 42.1 | 1.6 | 6.5 | 22.7 | 58.2 |
| 222 | 7.5 | 57.9 | 42.0 | 1.7 | 6.7 | 23.9 | 37.1 |
| 222 | 7.5 | 51.1 | 42.5 | 1.7 | 6.2 | 24.6 | 24.9 |
| 222 | 7.5 | 56.7 | 42.1 | 1.9 | 6.9 | 27.3 | 61.0 |
| 255 | 8.1 | 21.7 | 43.9 | 3.6 | 6.8 | 50.8 | 15.2 |
| 227 | 4.7 | 55.9 | 36.9 | 1.7 | 7.0 | 24.1 | 30.1 |
| 222 | 10.8 | 39.9 | 40.1 | 2.5 | 6.7 | 35.3 | 16.9 |
| 207 | 6.0 | 68.0 | 41.6 | 1.4 | 7.2 | 19.7 | 155.2 |

### REFERENCES

1. JOHNSTON, I. The Composition of the Cell Wall of Aspergillus niger. Biochem. J. 96, 651-658, 1965.
2. RUIZ, J. Chemical Components of the Cell Wall of Aspergillus Species. Arch. Biochem. Biophys. 122 (1), 118-125, 1967.
3. KUMAR, M. A review of chitin and chitosan applications. React. Funct. Polym. 46 (1), 1-27, 2000.
4. RINAUDO, M. Chitin and chitosan: Properties and applications. Prog. Polym. Sci. 31 (7), 603-632, 2006.
5. PILLAI, C, et al. Chitin and chitosan polymers: Chemistry, solubility and fiber formation. Prog. Polym. Sci. 34 (7), 641-678, 2009.
6. CAI, J. et al. Enzymatic preparation of chitosan from the waste Aspergillus niger mycelium of citric acid production plant. Carbohydr. Polym. 64 (2), 151-157, 2006.
7. SASAKI, M, et al. Cellulose hydrolysis in subcritical and supercritical water. J. Supercrit. Fluids, 13 (1), 261-268, 1998.
8. KUMAR, S, et al. Cellulose pretreatment in subcritical water: Effect of temperature on molecular structure and enzymatic reactivity. Bioresour. Technol. 101 (4), 1337-1347, 2010.
9. ROGANLINSKY, T. et al. Hydrolysis kinetics of biopolymers in subcritical water. J. Supercrit. Fluids, 46 (3), 335-341, 2007.
10. SASAKI, M, et al. Fractionation of sugarcane bagasse by hydrothermal treatment. Bioresour. Technol. 86 (3), 301-304, 2003.
11. GUOXIANG, L, et al. Dilute solution properties of four natural chitin in NaOH/urea aqueous system. Carbohydr. Polym. 80 (3), 970-976, 2010.
12. WESKA, R, et al. Optimization of deacetylation in the production of chitosan from shrimp wastes: Use of response surface methodology. J. Food Eng. 80 (3), 749-753, 2007.
13. YEN, M, et al. Physicochemical characterization of chitin and chitosan from crab shells. Carbohydr. Polym. 75 (1), 15-21, 2009.

1) Process for the preparation of chitin-glucan or chitosan-glucan complexes from raw materials of biological origin rich in chitin, which comprises the stages of:
a) Washing the biomaterial selected from mycelium of micro-fungi or exoskeletons of crustaceans until neutral pH, dry until reaching a relative humidity below 20%, and diminishing the particle size, where more than 90% of the particles have an average diameter lower than or equal to 1 mm.
b) Mixing, at room temperature, the biomaterial pretreated in a proportion between 10 and 30%, water between 70 and 90% and a nonionic emulsifying agent with HLB between 10 and 20 in a proportion between 0.01 and 1%.
c) Heating the mixture at a temperature between 100 and 370° C., preferably between 200 and 250° C., where the operating pressure is equal to or above that of the water vapor pressure at the temperature selected for the reaction, and let react between 0.1 and 50 s, preferably between 5 and 12 s.
d) Cooling the mixture to between 35 and 30° C. between 0.1 and 30 s.
e) Washing with water to remove proteins and sugars and recover the solid.
f) Drying the solid until reaching humidity percentage below 18%.

2) The process to prepare chitin-glucan or chitosan-glucan complexes from raw materials of biological origin rich in chitin from claim 1, characterized because sodium hyposulfite is optionally incorporated in a proportion between 0.1 and 5% and a base selected from sodium hydroxide, potassium hydroxide, lithium hydroxide, calcium hydroxide, or magnesium hydroxide in a proportion between 10 and 30%.

3) A chitin-glucan or chitosan-glucan complex obtained through the process of claims 1 and 2, characterized because it presents a chitin proportion between 19 and 55% and average molecular weight between 1.7 and 155 kDa.
